(19) United States
(12) Patent Application Publication
(10) Pub. No.: US 2008/0243360 A1
(43) Pub. Date: Oct. 2, 2008

(54) Method and System for Adjusting Electronic Ignition for Multiple Fuel Types

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/055,842

(22) Filed: Mar. 26, 2008

Related U.S. Application Data
(60) Provisional application No. 60/908,212, filed on Mar. 27, 2007.

(51) Int. Cl. F02D 41/30

(52) U.S. Cl. 701/103

(57) ABSTRACT

An engine control unit is configured to provide a fuel injector pulse width signal. A signal modifier comprises a fuel-type identifier in communication with the engine control unit. The signal modifier is configured to provide a 25% greater, modified pulse width signal to the fuel injector component in response to a switch selection. The pulse width signal is optimized for a gasoline blend and, more particularly, to an E85 fuel blend.

### RELATED APPLICATIONS

The present application is a Continuation-in-Part of U.S. Ser. No. 60/908,212 and it claims a priority to the provisional's Mar. 27, 2007 filing date. The present application incorporates the subject matter disclosed in ('212) as if it is fully rewritten herein.

### BACKGROUND OF THE INVENTION

### Field of the Invention

The present invention relates to systems for the controlled combusting of fuels, and, more particularly, to internal combustion engine systems configured to operate on multiple types of fuel.

### BACKGROUND OF THE INVENTION

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based fuels, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

However, conventional internal combustion gasoline or diesel engines are designed to operate on fuel specifications that severely limit the possibilities of using alternative fuels on a large and meaningful scale. Known alternative fuel blends diverge greatly from conventional petroleum-based fuel specifications, and thus replacing a petroleum fuel blend with an alternative fuel requires significant reconfiguration of engine system and, more particularly, of engine ignition and fuel supply systems. Once reconfigured, the altered systems can no longer acceptably function with conventional gasoline blends. The owner or operator of a conventional automobile must choose between relying on a ubiquitous petroleum fuel, readily available through a huge well-developed fuel production and supply system, or reconfiguring his automobile to run instead on an alternative fuel, which may be difficult to obtain and have uncertain future supply and pricing characteristics. Switching back to the petroleum fuel blend, however, at some future point will result in service costs and efficiencies.

Thus, what is needed is a method or system that addresses the problems discussed above, as well as others, for example, enabling a conventional automobile to efficiently use both conventional petroleum fuel blends and alternative fuels.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system; and,

FIG. 2 illustrates portions of an automobile fuel injector system in accordance with a preferred embodiment of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

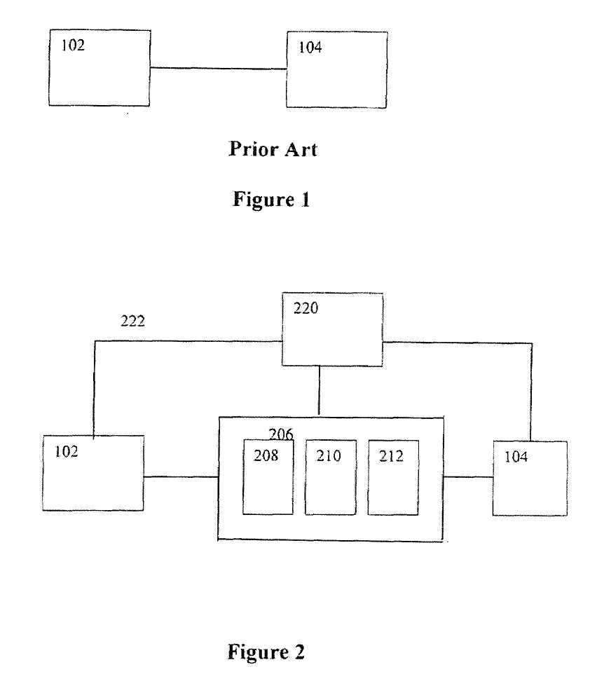

Referring now to FIG. 1, a PRIOR ART gasoline internal combustion engine configuration is illustrated wherein an engine control unit (ECU) 102 is shown in communication with an automobile fuel injector component 104. The ECU 102 may also communicate with or control other automobile systems, e.g., ignition timeing and transmission systems (not shown). The ECU is sometimes referred to is an Engine Control Module (ECM) or a Powertrain Control Unit/Module (PCU,PCM). The fuel injector component 104 comprises a plurality of electronically controlled valves with at least one valve provided for each engine cylinder. The valves are each supplied with pressurized fuel by a fuel pump (not shown). The valves are configured to open and close many times per second. The amount of fuel supplied to the engine is determined by the amount of time the fuel injector stays open, called the “pulse width”. The length of time is controlled by pulse width signals controlled by the ECU.

The ECU 102 pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

The ECU 102 monitors the mass of air entering the engine, the amount of oxygen in the exhaust and other engine system performances and uses, one or more formula(s) and a large number of lookup tables to determine the pulse width for a given operating condition, avoiding too-rich and too-lean AFRs by increasing or decreasing fuel injector 104 pulse widths in real-time in a closed-loop control system. The ECU 102 generally computes more than 100 parameters, each having its own lookup table, and some of the parameters even change over time in order to compensate for changes in the performance of engine components, s.a., e.g., a catalytic converter. Depending on the engine speed, the ECU 102 performs these calculations over a hundred times per second.

Problems arise if the ECU 102 is used with alternative fuels. For example, E85 fuel combustion generates lower energy as measured in British Thermal Units (BTUs) than gasoline fuel blends, and thus higher pulse widths are required to generate comparable engine performances under similar operating parameters. And reconfiguring the ECU 102 to produce appropriate pulse width signals for more than one anticipated fuel blend is not practical in view of the complex computational demands placed upon the limited available ECU 102 processor resources for even one fuel type.

FIG. 2 provides an alternative fuel injector control system according to the present invention, wherein a Pulse Modifier 206 is provided interposed between the ECU 102 and the fuel injector component 104. In the present invention, the Pulse Modifier 206 modifies the ECU 102 pulse width signals to enable the fuel injectors 104 to efficiently operate on one or more alternative fuels. In one embodiment optimized for E85 fuel, the Pulse Modifier 206 widens the ECU 102 pulse signal by about 25%. Alternative embodiments may use other percentage amounts, linear or algorithmic pulse width modifier techniques dependent on one or more parameters. Other embodiments may be configured to modify pulse width signals in response to one or more other anticipated alternative fuel requirements. The Pulse Modifier 206 may be programmed or otherwise configured by a manufacturer, an alter-market retailer or installer, or by some other service provider. It may also be subsequently re-programmed as required to provide optimal fuel injector settings for one or more specified alternative fuels.

In the present embodiment, the Pulse Modifier 206 may be manually adjusted through a manual adjustment means 208, though this option and this component is optional. When engine performance is observed, automobile user preferences or other requirements indicate a richer or a leaner alternative fuel-oxidizer ration. The manual adjustment means 208 may then be used to increase or decrease the amount of the pulse width increasing/decreasing performed by the Pulse Modifier 206. In one embodiment, the manual adjustment means 208 is an analog dial-type of switch, wherein turning the dial means 208 in a first direction increases a pulse width multiplication factor and turning it in an opposite direction correspondingly decreases that multiplication factor. The amount of adjustment may be user determined, or in some examples it may be specified based upon a correlation with one or behavioral observations. Manual adjustment means 208 examples also include rotary dip switches, potentiometers, and digital input means, s.a., keyboard entry means. Other possible manual adjustment means 208 are readily apparent to one skilled in the arts.

The Pulse Modifier 206 enables a conventional automobile to use either conventional gasoline or one or more alternative fuels by operation of a switch means 210 within the Pulse Modifier 206. When an automobile owner or operator chooses to use a conventional gasoline blend, the user toggles the switch 210 to place the Pulse Modifier 206 in a passive or inactive mode, wherein the pulse Modifier 206 passes the ICU 102 pulse width signals directly to the fuel injectors 104 without modification. When instead an alternative fuel is used, the switch means 210 is toggled to activate the Pulse Modifier 206, which then modifies the ECU 102 pulse width signals as discussed above. The modified pulse width signals arc sent to the fuel injectors 104.

In another example, behavior of the ECU 102, the Pulse Modifier 206, and the fuel injectors 104 or other automobile systems may be monitored by a service provider 220. Monitoring may be performed locally or remotely through a communication network 222, wherein illustrative examples include the internet, a local area network (LAN), a wide area network (WAN), Bluetooth® network communications and/or cellular network communications (such as OnStar® network communications). The service provider 220 may thus perform or offer to perform monitoring, Pulse Modifier 206 adjustment and/or maintenance services on a subscription basis to an automobile owner or operator.

Thus one advantage of the present invention is that the Pulse Modifier 206 may be easily incorporated into a conventional automobile to allow an owner/operator to easily switch back-and-forth between fuel types is desired. The automobile is thereby operated on either a conventional fuel blend or oil one or more alternative fuels. By passing conventional pulse width signals from the ECU 102 unimpeded and directly to the fuel injector component 104 in the passive/inactive mode, the Pulse Modifier 206 has no impact on conventional fuel use and operations, and thus no adverse impact on automobile performance. But when an alternative fuel is chosen and supplied, the appropriate modified pulse width signals are easily produced and provided to the fuel injectors 104. Switching back-and-forth between fuel types does not require expensive and time-inefficient servicing of the automobile; rather, it merely requires an operation of the switch means 210.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Still yet, any of the components of the present invention could be deployed, managed, serviced, etc., by a service provider who offers to manage fuel injector settings through the components and steps described above. In another embodiment, the invention provides a business method that performs the process steps of the invention on a subscription, advertising and/or fee basis. In this case, the service provider can create, maintain, and support, etc., a computer infrastructure, s.a., the computer infrastructure 220 that performs the process steps of the invention, for one or more customers. In return, the service provider can receive payment from the customer(s) under a subscription and/or fee agreement and/or the service provider can receive payment from the sale of advertising content to one or more third parties.

Having thus described the invention what is claimed as new and desired to be secured by Letters Patent is as follows:

1. A system, comprising:
an engine control unit configured to provide a fuel injector pulse width signal;
a signal modifier in communication with the engine control unit and comprising a switch, the signal modifier configured to modify the pulse width signal to generate a modified pulse width signal; and,
a fuel injector component in communication with the signal modifier;
wherein the signal modifier is configured to provide the pulse width signal or the modified pulse width signal to the fuel injector component in response to a switch selection.

2. The system of claim 1, wherein the pulse width signal is optimized for a gasoline blend, and wherein the modified pulse width signal is optimized for an E85 fuel blend.

3. The system of claim 2, wherein the signal modifier further comprises a manual adjustment means configured to increase or decrease an amount of pulse width modification.

4. The system of claim 3, wherein the manual adjustment means is selected from the group comprising:
an analog dial-type switch,
a rotary dip switch:
a potentiometer; and,
a digital input means.

5. The system of claim 3, wherein the modified pulse width signal is an amplification of the pulse width signal.

6. The system of claim 3, further comprising a service provider in communication with at least one of the engine control unit, the signal modifier and the fuel injector component, the service provider is configured to monitor at least one of the engine control unit, the signal modifier, and the fuel injector component, the service provider provides a notification of an event occurrence.

7. A method, comprising the steps of:
generating a pulse width signal optimized for a first fuel in response to at least one engine operating parameter;
generating a modified pulse width signal by modifying the pulse width signal;
identifying a fuel;
selecting the pulse width signal or the modified pulse width signal in response to the step of identifying the fuel; and,
providing the select pulse width signal or the modified pulse width signal to a fuel injector operating with the identified fuel.

8. The method of claim 7, further comprising the steps of:
optimizing the pulse width signal for a gasoline blend; and,
optimizing the modified pulse width signal for an E85 fuel blend.

9. The method of claim 8, wherein the step of modifying the pulse width signal comprises widening the pulse width signal by a widening factor.

10. The method of claim 9, further comprising a step of manually increasing or decreasing the widening factor.

11. The method of claim 8, further comprising the steps of:
monitoring at least one of an engine control unit configured to generate the pulse width signal, a signal modifier configured to generate the modified pulse width signal and a fuel injector component; and
notifying at least one of an engine control unit event occurrence, a signal modifier event occurrence, and a fuel injector component event occurrence;
wherein monitoring and said notifying is performed by a service provider.
